(19) United States
(12) Patent Application Publication
(10) Pub. No.: US 2006/0136880 A1
(43) Pub. Date: Jun. 22, 2006

(54) System, apparatus and methods for automatic program translation

(76) Inventors: Hironao Sone, Tokyo (JP); Shoichi Hirasawa, Tokyo (JP)

Correspondence Address: INGRASSIA FISHER & LORENZ, P.C., 7150 E. CAMELBACK, STE. 325, SCOTTSDALE, AZ, 85251, US

(21) Appl. No.: 11/285,865

(22) Filed: Nov. 23, 2005

(30) Foreign Application Priority Data
Jul. 20, 2004 (JP) JP 2004-211900
Jul. 20, 2005 (JP) JP 2005-013674

(51) Int. Cl. G06F 9/45

(52) U.S. Cl. 717/136; 717/106

(57) ABSTRACT

A Java application is converted to be used in BREW. A program for automatic translation, which selectively constructs, in a computer, either first means for converting a Java source code into a binary code or second means for directly converting a Java byte code into the binary code, is mounted in advance in a program translation server provided in a computer network arbitrarily accessible by an operation terminal of a developer. When the operation terminal of the developer inputs an application composed of a Java (source/binary) code to the program translation server, the application is automatically converted into a BREW application, and returned to the operation terminal.

### PRIORITY

This application claims priority to PCT Patent Application No. PCT/JP2005/013674 entitled “PROGRAM FOR AUTOMATIC TRANSLATION, AND PROGRAM TRANSLATION SERVER”, filed Jul. 20, 2005, which claims priority to Japanese Patent Application No. 2004-211900, filed on Jul. 20, 2004. Both of these documents are incorporated herein by reference.

### TECHNICAL FIELD

The present invention relates to automatically translating software programs written in one computer language and/or development environment into another language or environment. Such systems and techniques may be used, for example, in developing applications for cellular telephones.

### BACKGROUND

Mobile telephone consumers are now able to download and use various software applications and other services that were not previously available. Many of these programs and services are written in the JAVA programming language developed by Sun Microsystems, Inc., which is highly portable across different types of hardware, and which has been widely deployed on many types of cellular and other wireless phones. Many conventional JAVA implementations, however, require the wireless phone to execute a relatively large and complex software application called JavaVM, or “Java Virtual Machine”. In particular, the JAVA virtual machine typically requires that the phone provide separate processing resources for communication and for running JAVA applications on the cellular phone. Due to the resources typically required to execute the JavaVM, availability of certain programs and services has been limited to relatively high-performance hardware, thereby limiting widespread deployment of various services and programs to other users.

Meanwhile, many mobile phones are capable of executing programs written in conventional software languages other than JAVA such as “C” and “C++”. Such languages have been heretofore used as mainstreams of software development, and can be implemented using one or more readily-available libraries residing on a wireless phone. In particular, the BREW (Binary Runtime Environment for Wireless) environment developed by Qualcomm Incorporated has been widely deployed across the wireless industry worldwide. Programs written for this environment are commonly called “BREW Applications”, and software written in such environments typically exhibits improved performance as compared to software written in the JAVA environment.

As described above, a large number of JAVA applications for cellular phones have been developed and sold. Since BREW technology is more recently developed than JAVA, the number of BREW applications heretofore developed is significantly smaller than the number of Java applications. Since software is typically developed manually, development and deployment of new software programs that exploit newer technologies can be time consuming. It is therefore desirable to facilitate software development in BREW and other emerging technologies in a manner that is expedient and efficient.

While various attempts have been made to allow JAVA programs to work within the BREW library framework, it remains a relatively time-consuming task for a developer to develop a BREW application from a JAVA program. The relevant libraries typically need to be manually selected, for example, thereby necessitating manual developer action. Moreover, JAVA contains various features that are not available in conventional BREW franeworks. JAVA typically provides automated “garbage collection (GC)” for releasing unused memory, for example, which is not typically available in the BREW environment. As a result, it is typically necessary for BREW developers to manually develop new libraries to implement such features. Further, unlike JAVA programs, it may be necessary to manually modify BREW programs tailored to particular phones to exploit new features such as higher screen resolution, improved processing performance, flat-rating of communication fees and the like. To complicate the conversion process even further, JAVA itself contains various linguistic dialects such as JAVA for NTT DoCoMo, Inc. and JAVA defined by Sun Microsystems, Inc. Applications developed by the respective versions of JAVA are typically incompatible with one another.

As a result of the various complications in converting programs developed in JAVA to work in other environments, development of mobile phone applications can be relatively cumbersome. For applications originally developed in JAVA, for example, another development process is typically required to duplicate the same application in BREW, with associated development times and costs. Moreover, such conversion typically requires programmers to be skilled in both JAVA and BREW technologies, or for multiple programmers with expertise in the two technologies to work together. In such cases, the cost incurred by the duplicate development times and human resources can be significant. It is therefore highly desirable to streamline the process of translating software programs written in one computer language and/or development environment into another language or environment.

### BRIEF DESCRIPTION OF EXEMPLARY EMBODIMENTS

In order to solve the above-described problems, various embodiments of the present invention provide suitable programs and techniques for automatic translation, as well as program translation servers. In one embodiment, a program for automatic translation (i.e. conversion) automatically converts a Java application into a BREW application without the need for manual conversion. Such embodiments of the program suitably include, in a computer: first means for converting a Java source code into the binary code; and second means for directly converting a Java byte code into the binary code, wherein “means” relates to any type of hardware, software, firmware and/or other logic capable of processing data as described herein.

In various further embodiments, from a viewpoint of simplifying processing of the translation, an exemplary program further includes library management means for storing a library in a predetermined memory in association with an identification code for identifying a type of JAVA code forming an individual Java program, the library defining a procedure for converting each of plural types of JAVA applications, which is individually different in profile, into a BREW application; and third means for reading out, when the type of JAVA code is specified, a library corresponding to JAVA code of JAVA application to be converted from the memory through the library management means, and prompting either the first means or the second means to automatically convert JAVA application described in the specified Java code into BREW application based on the read-out library.

In still other embodiments, the computer further includes data structure analysis means for reading contents data to be used in the JAVA application. This data may include, for example, image data, sound data, or data formed by combining these elements. The data structure analysis means further specifies a data structure of the contents data; and data structure translation means for converting the data structure specified by the data analysis means into a data structure to be used in BREW application.

An exemplary program translation server suitably includes an automatic translation program capable of automatically converting a Java application described in a Java source code or a Java byte code into a BREW execution format described in BREW binary code. The server also appropriately includes library management capability for storing a library in a predetermined memory in association with an identification code for identifying a type of JAVA code forming an individual Java program, the library defining a procedure for converting each of plural types of JAVA applications individually different in profile into BREW applications. Further, the server appropriately includes a code reception module for receiving JAVA code to be converted in a format of electronic data through a predetermined computer network; translation means for reading out a library corresponding to JAVA code received by JAVA code reception means from the memory through the library management means when a type of JAVA code is specified, further reading out the program for automatic translation from the program storage means, and executing the program for automatic translation by using the read-out library, thereby converting the received Java code into the binary code; and returning the converted binary code to a transmission source of JAVA code.

In one embodiment, the program translation server is constructed to further comprise user registration means for registering a user desiring to convert JAVA code into the binary code, wherein the reception of JAVA code from the user registered in the user registration means per one-time charge is repeatedly permitted.

According to an exemplary embodiment of a program translation server, an application developer can receive an automatically converted binary code (execution code) of BREW from a JAVA byte code. The translation service is appropriately automated, thus making it possible for the developer to finish the development in a comparatively short period of time. Other features and aspects of various exemplary embodiments are described more fully below.

### BRIEF DESCRIPTION OF THE DRAWING FIGURES

The present invention will hereinafter be described in conjunction with the following drawing figures, wherein like numerals denote like elements, and:

FIG. 1 is a schematic view of an exemplary system for a translation program;

FIG. 2 is an explanatory view showing an example of a Java application;

FIG. 3 is a view showing an example of a BREW application created by a Java 2/BREW translator;

FIG. 4 is a schematic explanatory view of an exemplary system for automatic translation processing;

FIG. 5 is a schematic explanatory view of an exemplary preprocessing system;

FIG. 6 is a block diagram view showing an exemplary process for converting pre-processed data into BREW or other source code;

FIG. 7 is a schematic explanatory view of exemplary processing for compiling the converted BREW source code into a BREW binary file; and

FIG. 8 is a detailed procedure explanatory view of an exemplary translation process.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

With reference to the various drawing figures, a service system can be realized by providing a program translation server in a computer freely accessible by an application developer via a network or otherwise. The translation server suitably includes program storage (e.g. a disk, memory, optical or magnetic disk, and/or other static or dynamic storage media) for storing the automatic translation routines, as well as other programs (OS, BIOS, and the like) as appropriate. The server also includes data structures, hardware and/or software logic, programming routines and/or other data processing constructs for registering users, managing JAVA libraries, receiving JAVA code, translating code, providing output, and/or performing other functions as appropriate.

In a typical embodiment, the program translation server is a computer having a server program and including a processor (CPU) and a memory storing computer programs read and executed by the processor. The program for automatic translation can be implemented as one of the computer programs stored in memory, mass storage or the like.

The program for the automatic translation is executed in the computer, thus making it possible to convert the large number of already existing Java applications into BREW applications in an extremely short period and at low cost by eliminating manual work. In the case of the automatic translation, the translation can be performed both from a source code of JAVA and directly from a machine language called JAVA byte code, and accordingly, it is made possible to perform the program translation extremely easily.

JAVA byte code is a format used in many conventional JAVA applications. In various embodiments, the benefits of direct translation from JAVA byte code can be significant. In particular, when a development company develops an application, security contracts may be present that may restrict the availability of actual source code. Alternatively, copyright or other logistical issues may prevent or hamper access to actual source code. Even in such cases, however, it may be possible to perform conversions of Java byte codes provided in a conventional execution environment.

Moreover, in order to provide a program for converting an application into BREW application regardless of the profile in which the original JAVA application is described, as to libraries for translation, a library for a particular profile is provided. In the case of Java (DoJa) for NTT DoCoMo, Inc., for example, a library for DoJa is prepared in advance, and a second library is prepared in advance in the case of Java (MIDP) for Sun Microsystems, Inc., and/or the like. Upon translation, a library corresponding to the original application to be translated is selected and used, thus making it possible to absorb differences of various profiles, and to perform the translation into BREW or another suitable format from any source “flavor” or variety of Java.

Further, although various ones are used as image and sound data to be used for the application depending on the respective communication carriers, a program is provided in various embodiments that automatically detects and decodes the data no matter what communication carrier the data belongs to. Image data for NTT DoCoMo, Inc., for example, employs a compression format called “gif”, and image data for KDDI Corporation employs a compression format called “png”. The automatic translation program is provided with a function to analyze the format and structure of the data to be used. In such a way, a function to be capable of utilizing the image data and the sound data according to the compression formats thereof is provided.

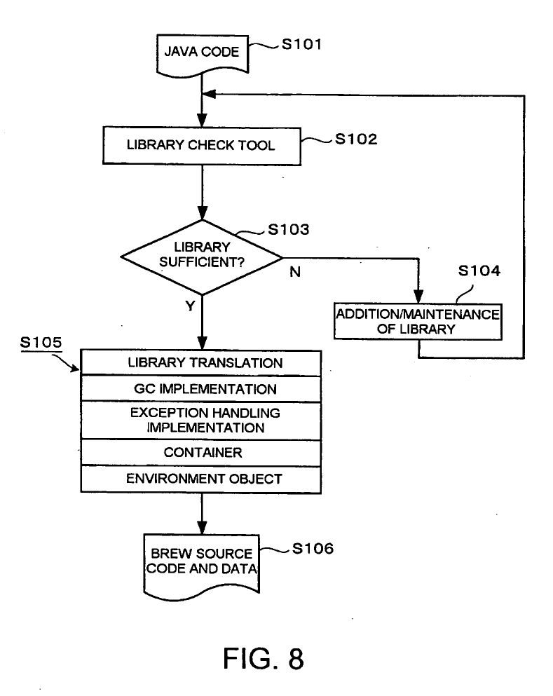

With initial reference to FIG. 8, an exemplary program for automatic translation may be implemented through the interaction of, for example, a group (aggregate) of programs or modules each carrying out various features. The particular programs used in any particular embodiment may vary, but may include one or more of the programs that provide such features as library translation, GC implementation, exception handling, container functionality, and/or environmental objects.

Library check tool S101 is any tool for verifying, before actually performing the automatic translation, whether the libraries to be used in the Java applications are convertible by a translation tool. Because automatic translation cannot typically be performed when the requisite libraries are not sufficiently present, it can be beneficial to execute the automatic translation after the necessary libraries are complete.

The library check tool S101 first extracts libraries being actually used from a constant pool, a field, and/or a method (all of which can be according to specifications for the JAVA language or the like) from a class file of a Java application to be converted. Thereafter, library check tool S101 compares the extracted library with a list of already implemented class libraries S103, and displays information as to whether the group (aggregate) of libraries used by JAVA application is entirely included in the class list of the already implemented libraries, or information on the number of libraries that are not included if all the libraries are not included, and information as to what is the libraries that are not included (e.g. S104 in FIG. 8).

In handling exceptions within the JAVA language, specific processing designated in a Java class file at the time of a method call (e.g. specific processing, arithmetic function, and the like) and a field access (reference to data) can be performed when JAVA is executed. A function of this exception handling may be realized in a BREW destination program or the like.

In order to realize the function in the translated BREW program, in this embodiment, investigation of whether an exception has occurred is inserted after processing. Such information may be described in a class file, such as in a method call and/or a field access that represents the possibility that the exception occurs. When the exception occurs, specific processing (described in the class file or field access) can be performed, thereby allowing exception handling similar to that of JAVA to be implemented in BREW.

A container is any program for reproducing, in a BREW or similar environment, an execution framework in a Java mobile application. In JAVA, events for initialization, starting, suspension (stopping), resuming, and the like are generated, and for the respective events, application programs and library programs perform operations conforming to a predetermined Java standard.

The “container” is therefore any program or other code module capable of generating similar events for a BREW application and of controlling the operations of the application programs and the library programs for the respective events. The application programs differ for each application, and accordingly, it may be necessary to create a container corresponding to each application in various exemplary embodiments.

In order to automatically convert the program into a BREW application, an object including data to be used by the container, the application programs, and the library programs is provided. This object is referred to “environment object”.

Environment object can be realized, for example, by collecting and recording commonly usable data from some or all of the programs. Such data includes, for example, data regarding the above-described GC, static data in JAVA language, and the like. In the case of the static data, it may be helpful to record static data individually corresponding to application classes and library classes. The application programs differ for each application, and accordingly, an environment object corresponding to each application may be created.

Library translation provides a BREW or similar program having any corresponding function as a standard library according to a Java language (or other source) specification. The library exchange is realized by creating this BREW program for doing the same action as the standard library for each Java library class and by maintaining the library. For example, a “java_lang_String class” may be implemented with BREW to correspond to the conventional “java.lang.String class” as a result of library translation. In a library class implemented with BREW, a method (processing) having the same field (data) and doing the same action as the library class of JAVA can be provided. The field and the method may have interfaces (i.e. calling rules) and other features that are approximately equivalent to those of JAVA.

An exemplary processor of the program translation server suitably performs the following internal processing steps by reading and executing the program for the automatic translation.

1. Preprocessing of a Java application file (e.g. as shown in FIG. 5);

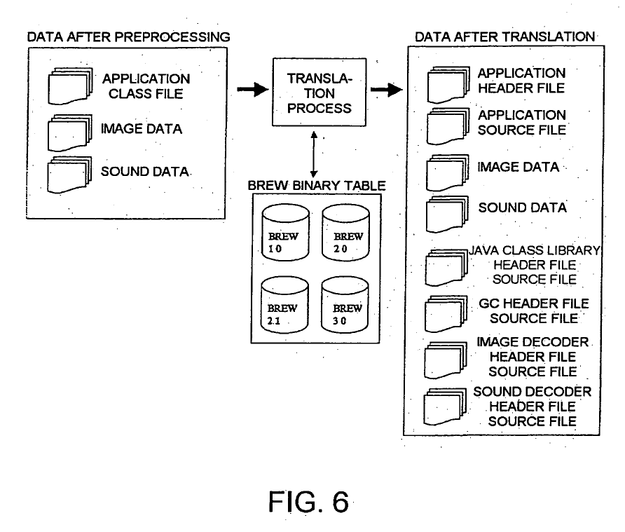

2. Translation of data after preprocessing into BREW source code (e.g. as shown in FIG. 6);

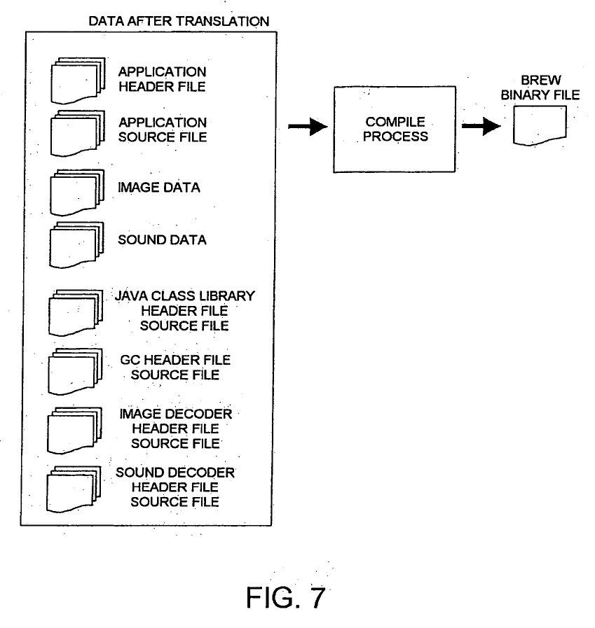

3. Compilation of BREW source code to BREW binary code (e.g. as shown in FIG. 7).

Each of the internal processing steps is described below.

1. Preprocessing of Java Application File

With primary reference now to FIG. 5, a JAVA application file is typically compiled into a single file when received from a requestor. The application file is therefore decomposed into an application class file, files of data of images, sounds, and/or the like. While different types of Java to be inputted may include (for example) DoJa for NTT DoCoMo, Inc., standard of Sun Microsystems, Inc., MIDP JAVA and/or the like, the Java version information submitted from the development requester can be added to the decomposed data. This information, in turn, can be handed to subsequent translation processing to provide information for performing translation corresponding to a particular profile corresponding to the “flavor” of JAVA used to implement the original application.

An outline of an exemplary preprocessing technique is shown in FIG. 5. JAVA application file and JAVA version information are suitably inputted from the development requester. In the JAVA application file, the data is compressed to be compiled as a Jar file or the like. Accordingly, extraction processing is performed for this Jar file by using a Jar command, and the Jar file is decomposed into the application file, the files of the image data, the sound data, and the like. While techniques other than JAR may be used in alternate embodiments, the Jar file is a widespread and standard format that can be readily recognized and implemented as a distribution method. The Jar. file can be subsequently extracted and expanded by using the conventional Jar command or any number of commercially-available tools.

2. Translation of Data After Preprocessing into BREW Source Code

The data after the preprocessing is appropriately converted into BREW source code. Specifically, JAVA application file is converted into a header file of C++ and a program file. While some versions exist also in BREW as a translation destination, such as BREW 1.0, BREW 2.0, BREW 2.1, and BREW 3.0, a method of converting JAVA application file into a version designated from the development requester with reference to a BREW library DB in a translation process is described here as an exemplary embodiment.

Details of the translation are described with particular reference to FIG. 6. In a Java source file and Java class file, information describing the method of executing the program, such as the class, the field, and the method, is contained. These class, field, and method are converted so as to be along with grammar of the C++ language, or any other suitable language that can be converted or understood. The JAVA fields and methods are appropriately converted into corresponding fields and methods in accordance with the C++ language to perform the same functions and operations, respectively. In such a way, each class of JAVA is converted into a class of the C++, and the converted class of the C++ operates on an execution environment of the C++ (including BREW environment). This is similar to an operation on a Java execution environment of a Java class that has served as a translation source, and therefore may be readily implemented.

The class(es) of the JAVA application operate within the JAVA execution environment, and the converted C++ class(es) perform the same operations as the JAVA classes, as appropriate. From the above, the application converted into the C++ language performs the same operation as the JAVA application serving as the translation source, but operates within a C++ or similar environment compatible with BREW or the like.

In the case of the translation, the application class file created by the preprocessing is converted as the application header file and the application source file in the C++ language. Moreover, besides this translation, JAVA class library to be used in this application is also added to the data after the translation with reference to a BREW library.

Moreover, for functions (for example, GC) present within the JAVA language but not in C++ or the like can be added to the converted data after the translation. Furthermore, when compressed image data to be used in JAVA to be inputted is different from that of the image data supported by BREW (for example, when the image format in JAVA is a GIF format, and the image format to be used in BREW is not the GIF format), a decoder function for the format can also be added to the data after the translation. Also for the sound data, similar processing may be performed.

A JAVA application class file of the preprocessed data is suitably converted into the application header file and application source class file of the C++ according to the version of BREW, which has been designated from the development requester. Moreover, the JAVA class library being used in JAVA application file can also be added as a source file to the application file of the C++. As other files, a GC source file, an image decoder file, a sound decoder file, and the like are added to the source file of the C++ as needed.

The translation process in FIG. 6 is performed, for example, in a procedure shown in FIG. 8. Specifically, the processor of the program translation server activates the library check tool upon acquiring JAVA code (Steps S101, S102). If the library is not sufficient for translation, the processor performs the maintenance to add the files to the library as described above until the library becomes sufficient for translation (Step S103: N, Step S104).

When the library becomes convertible, the processor of the program translation server executes the program for the automatic translation, and performs the library translation, the GC implementation, the exception handling implementation, the container, and the environment object (Step S103: Y, Step S105). In such a way, the processor obtains BREW source code and data (Step S106).

Note that, in this embodiment, description has been made of the method of preparing in advance BREW library DB according to the version of BREW, which has been designated from the development requester, and of performing the translation by using BREW library DB in the case of the translation; however, according to another embodiment, it is also possible to carry out a method of compiling the libraries to be converted, determining the version at the time of executing the translation, and performing necessary processing.

3. Compilation of BREW Source File to BREW Binary Code

The created BREW source file is appropriately compiled to BREW binary code by using a compiler for a CPU being used in the cellular phone. The header file and source file of the created application, the header file and source file of the created class library, and in addition, the header files and source files for the GC, an image decoder, and a sound decoder, are converted to be source codes executable in BREW environment as appropriate. Accordingly, by compiling the above-described files by using a compiler (e.g. any compiler available from ARM Ltd., the gcc compiler, and/or the like) capable of creating a suitable BREW application, a binary for BREW environment is created.

An outline of the processing for compiling the converted BREW source code into BREW binary file is shown in FIG. 7. The data after being compiled is thereafter sent to an application development company from an automatic translation service system.

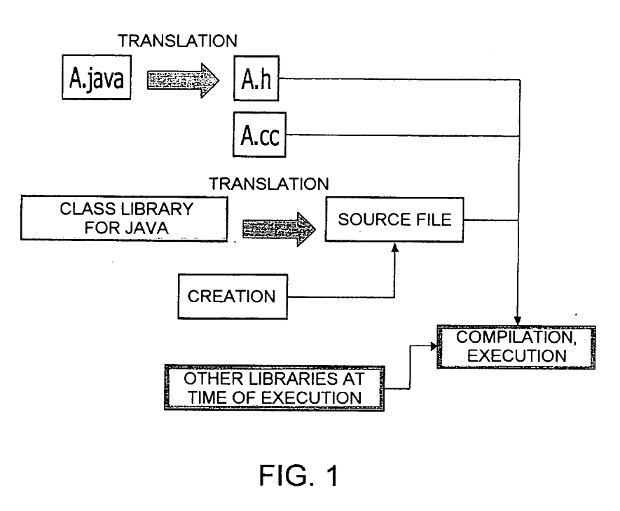

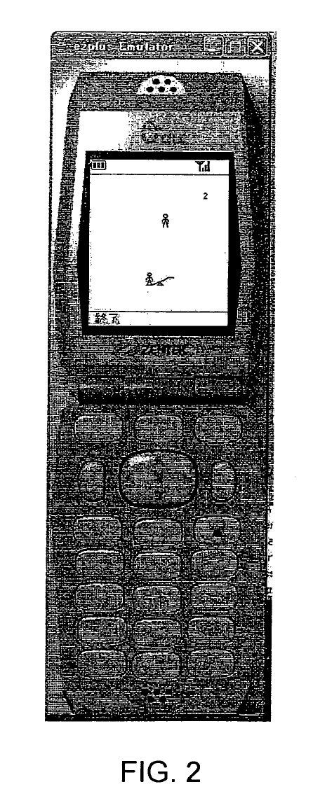

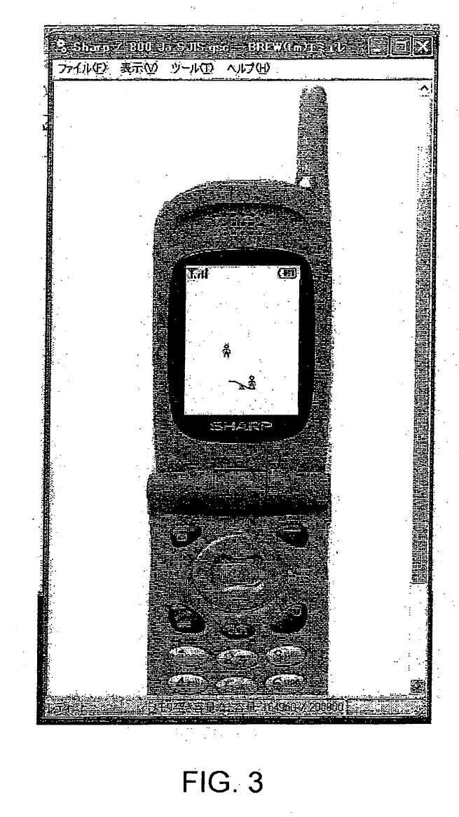

FIG. 1 shows an exemplary outline of the processing of the above-described 1 to 3 steps. Moreover, examples where the program actually converted by using the translation program is made to run on the cellular phone are shown in FIG. 2 and FIG. 3. FIG. 2 shows an example before the translation, and FIG. 3 shows an example after the translation. While these views show a simple video game implementation, any other types of applications may be equivalently converted using the techniques and structures described herein.

Moreover, an example of BREW application created by an exemplary JAVA 2 BREW translator is shown in FIG. 7 to create an application that operates in a Java terminal and in a BREW terminal in the same manner. The application shown in FIG. 2 and FIG. 3 is a game program, and FIG. 2 shows the screen output of Java application and FIG. 3 shows that of the program translated into JAVA application. Although the images illustrated in FIG. 2 and in FIG. 3 slightly differ from each other, this is due to the fact that the images are individually captured in this embodiment. Alternate embodiments may not include such functionality.

To perform the work of verifying, debugging, and adjusting the application, various embodiments provide a method of improving the application by using JAVA source code, reconverting a resulting application, and verifying, debugging, and adjusting the application. In the application development company, the application is developed by JAVA, and the automatic translation service is utilized, thus making it possible for the application development company to receive the translation result instantaneously, and to verify, adjust, and debug the translation result.

Moreover, JAVA source code is improved after being verified, adjusted, and debugged, and JAVA application file as a result thereof is subjected to the translation service. In such a way, JAVA application file can be subjected to the translation service any number of times, and fine improvement of the application can be performed across multiple platforms without significant additional work.

By exploiting the concepts described herein, the effort expended to create one or more BREW applications can be reduced significantly.

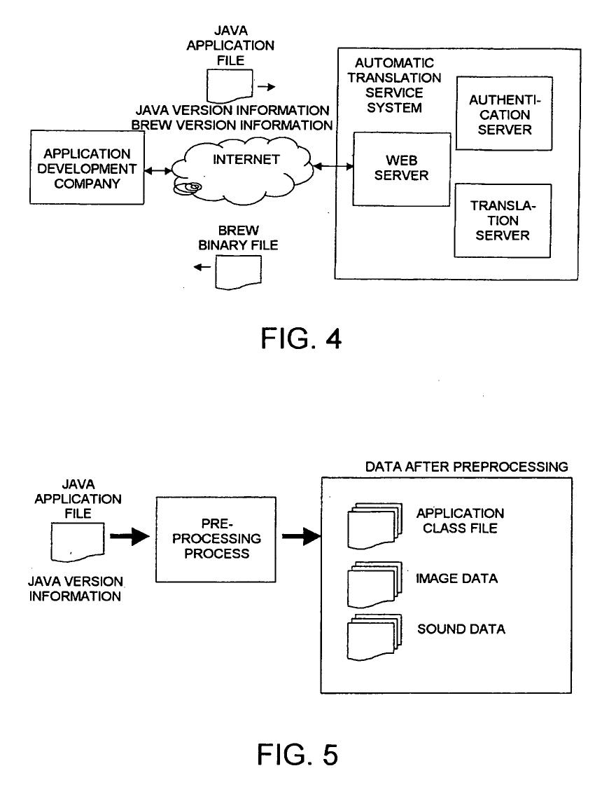

An operation example of the system performing the program translation service is described with reference to FIG. 4. As shown in the figure, a functional block diagram of an automatic translation service system is provided. In the case of utilizing the automatic translation service, the application development company concludes a contract with an automatic translation service providing company through the WEB or the like. Alternatively, the automatic translation server may be used on an internal network, freestanding personal computer or workstation, and/or the like.

As shown in FIG. 4, a web page for the application to be converted is prepared in a WEB server of the automatic translation service system. By filling in the page, a proposal for utilization of the automatic translation service is appropriately received by the service.

The application development company that has made the proposal for the utilization sends the JAVA application file to be subjected to the translation service to the automatic translation service providing company through the network, e.g., through the Internet. The version information of JAVA and the version information of the desired BREW application to be translated are associated with the JAVA application file. Moreover, the application development company could additionally provide information about any petition for a class ID or the like (e.g. a class ID requested from Qualcomm Incorporated). The automatic translation service providing company registers, in an authentication server, the application development company, JAVA application file information, the version information of JAVA, the version information of translated BREW, and the class ID of the application. After the application development company has registered with the server for the first time, subsequent registration may not be necessary, or may be streamlined to reduce re-entry of duplicate information.

After appropriate information such as the JAVA application file information, JAVA version information, the version information of the desired BREW translation destination, and/or the class ID of the application are received at the translation server, the translation processing is executed. A BREW binary file resulting from the processing is then transmitted to the application development company after the translation processing is finished.

Subsequent debugging, testing and the like may be additionally performed using the translation server. In one such scenario, the application development company performs the verification, adjustment, and debugging of the sent BREW binary code as appropriate. In case there is a problem and improvement is necessary in this process, the improvement is performed by using JAVA source code, and a JAVA application file as a result thereof is sent to the automatic translation service system one more time, and is subjected to the translation service. By using this method, it is made possible to repeatedly execute a development cycle necessary to adjust the program in an extremely short period.

In this case, even if the application development company tries to convert another application program based on the same application file information as previously registered, the BREW binary file returned as a result can be provided with a unique class ID added thereto. Accordingly, the BREW binary file can be restricted from being used as another program for service, resulting in an effect to prevent the translation service from being abused.

The program for the automatic translation, and the program automatic translation service by the server executing the program concerned, are therefore realized. In the case where JAVA application has already existed, it is made possible to develop BREW binary file in an relatively short time, and to provide a BREW binary file for service. Moreover, the system may be designed to be capable of performing the translation any number of times, thus making it possible to complete the program while shortening the development period (which goes around a cycle of original development, adjustment, debugging, and verification) of the whole program to a comparatively short period. In such a way, improvement of productivity of the program and effective utilization of program resources are achieved.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A program executable within a computer for automatically converting a Java application described in a Java code comprising at least one of a Java source code and a Java byte code into a BREW binary code compatible with a BREW execution format, the program comprising:
first means for converting a Java source code into the BREW binary code; and
second means for directly converting a Java byte code into the binary code.

2. The program of claim 1 wherein the program is configured to automatically convert the Java application to the BREW binary code without manual intervention from a user.

3. The program of claim 1, the program being for further constructing, in the computer:
library management means for storing a library in association with an identification code for identifying a type of the Java code forming the Java program, the library defining a procedure for converting each of a plurality of Java application types into BREW applications; and
third means for reading a library corresponding to the Java code through the library management means when one of the plurality of Java application types is specified, and prompting either the first means or the second means to automatically convert the Java application described in the specified Java code into the BREW application based on the library read from the memory.

4. The program for automatic translation according to claim 1, the program being for further constructing, in the computer:
data structure analysis means for reading contents data to be used in the Java application, and specifying what is a data structure of the contents data; and
data structure translation means for converting the data structure specified by the data analysis means into a data structure to be used in BREW application.

5. The program for automatic translation according to claim 4,
wherein the contents data comprises image data, sound data, or a combination thereof.

6. A program translation server for automatically converting, without manual input from a user, a Java application described in a Java source code or a Java byte code into a BREW application in an execution format described in a BREW binary code, the server comprising:
at least one library configured to define a procedure for converting each of a plurality of Java application types having individually different profiles into BREW applications; and
a translation program configured to read the at least one library corresponding to the individually different profile of the Java application and to automatically translate the Java application to the BREW application using the at least one library.

7. The program translation server of claim 6, wherein the translation program is further configured to return the converted binary code to a transmission source of the Java code.

8. The program translation server of claim 6, wherein the library further comprises a code for identifying a type of Java code forming the Java application.

9. The program translation server of claim 6 further comprising an interface to a digital network configured for receiving JAVA code to be converted in a format of electronic data through the computer network.

10. The program translation server according to claim 9, further comprising:
a user registration module configured for registering a user for translating Java code into the binary code, and for repeatedly allowing the reception of Java code from the user after registration.

11. The program translation server of claim 10 wherein the user registration module is configured to verify that the user has paid a charge before allowing the reception of Java code.

12. A method of converting a computer program from a first format compatible with a first application framework to a second format compatible with a second application framework, the method comprising the steps of:
pre-processing the computer program to separate the first format into an application class file and associated image and sound data;
translating the application class file and the associated image and sound data into source code compatible with the second application framework; and
compiling the source code to create an executable application in the second format.

13. The method of claim 12 further comprising the step of checking existing libraries in the second format to identify if the application class file contains features in the first format that are not present within the existing libraries.

14. The method of claim 13 wherein the features comprise garbage collection.

15. The method of claim 12 wherein the first format is Java and the second format is BREW.

16. A server comprising storage medium having computer-executable instructions stored thereon configured to execute the method of claim 12.

17. A digital storage medium having computer-executable instructions stored thereon configured to execute the method of claim 12.

18. A computer application configured to execute the method of claim 12.
